(19) United States
(12) Patent Application Publication
(10) Pub. No.: US 2010/0013251 A1
(43) Pub. Date: Jan. 21, 2010

(54) DEJECTA COLLECTOR FOR PETS

(76) Inventor: Tsuei-Jen YANG, Taipei City 100 (TW)

Correspondence Address: Dr. BANGER SHIA;Int''l Patent Office of Bang Shia, 102 Lindencrest Ct, Sugar Land, TX, 77479-5201, US

(21) Appl. No.: 12/176,743

(22) Filed: Jul. 21, 2008

(51) Int. Cl. A01K 29/00

(52) U.S. Cl. 294/1.3

(57) ABSTRACT

A dejecta collector for pets comprises a main body, a loading assembly and an elastic inserting member. One end of the loading assembly is assembled to one end of the main body, and the inserting member is inserted around the opening of the loading assembly and then connected to the main body for the user to control the loading assembly to open and close to hold and carry the dejecta of pets to the rubbish collection point.

### BACKGROUND OF THE INVENTION

1. Field of the Invention

The present invention relates to a tool for removing dejecta of pets, and more particularly to a dejecta collector for pets.

2. Description of the Prior Art

With the increase of the pets, the environment pollution caused by the dejecta of the pets is correspondingly increased. In order to solve the above problem, a wide variety of dejecta-cleaning devices have been developed on the market. Here, two of the conventional technologies of the dejecta-cleaning devices are described as examples.

The first conventional technology relates to a dejecta collecting device disclosed in Taiwan Pat No. 096215801, comprising a main body, a cover, linkage pieces and a grip. One end of the main body is formed with an opening and extended to form a loading surface. The cover is attached to the loading surface and pivoted to the main body at two sides thereof through the linkage pieces in such a manner that the cover can swing on the main body. Further analysis shows that the above conventional technology has the following problems:

The main body is pivoted to the cover through the linkage pieces, and there is no positioning arrangement between the main body and the cover, and thus the cover will swing on the main body uncontrollably, so that such a dejecta collecting device is inconvenient to carry.

The second conventional technology relates to a dejecta collector for pets disclosed in Taiwan Pat No. 093206770, essentially comprising an encloser to enclose the excretory organ of the pets. The encloser is provided with a through hole aligned with the pet excretory opening and a collecting bag enclosing the through hole. However, according to further analysis, the above second conventional technology has the following problems:

1. The pet's vigorous activates, such as running or rolling, will cause the shift of the encloser and the though hole of the encloser is unable to keep aligning with the pet excretory opening, so that the dejecta cannot drop into the collecting bag through the through hole and thus adheres to the arse of the pet, consequentially requiring the user to clean the pets frequently.

2. The enclosure worn on the pet for a long time will reduce the breath of the pet's skin while increasing the probability of the occurrence of skin diseases and consequentially affecting the health of the pets. Once the pets fall ill, the pet owners have to spend money and time taking the pets to see doctor.

The present invention has arisen to mitigate and/or obviate the afore-described disadvantages.

### SUMMARY OF THE INVENTION

The primary objection of the present invention is to provide a dejecta collector for pets, which unitizes an inserting member to control a loading assembly on a main body to open or close to collect the dejecta of pets.

In order to achieve the above objective, the dejecta collector for pets in accordance with the present invention comprises:

A main body is formed with an inner space formed with an opening at each of two opposite ends thereof.

A loading assembly includes plural supporting members and a sheet-shaped propping member made of cloth or paper, one end of each of the supporting members is pivoted to one another and fixed on the main body, the other end of each of the supporting members is provided for insertion of an inserting member, and the inserting member is inserted into the inner space of the main body from the opening at one end of the main body, the propping member is disposed on the supporting members.

A pull control device includes a passive member and an active member, the passive member is inserted into the inner space of the main body and fixed to the distal end of the inserting member, the active member is inserted into the inner space of the main body, one end of the active member is fixed to the passive member, and the other end of the active member is exposed out of the main body for the user to apply force on, the active member can be pulled to drive the passive member to pull the inserting member, thus controlling the propping member of the loading assembly to receive the dejecta of pets with the opening and closing of the supporting members.

As known from further analysis, the present invention can offer the following functions:

1. The loading assembly of the dejecta collector for pets is controlled to open or close by the inserting member on the main body, so that the user can timely collect the dejecta of pets, thus prevent the dejecta from adhering to the body of the pet.

2. The dejecta collector for pets utilizes the loading assembly to collect the dejecta of pets without wrapping a dejecta collector on the body of the pet, thus reducing the probability of the occurrence of disease and further reducing the time and money spent in taking the pets to see a doctor.

3. The components of the dejecta collector for pets are arranged through the other components, so that the dejecta collector for pets is easy for the user to take with him, and the main body can assists the disabled in walking.

### BRIEF DESCRIPTION OF THE DRAWINGS

FIG. 1 is an exploded view of a dejecta collector for pets in accordance with the present invention;

FIG. 2 is an assembly view of the dejecta collector for pets in accordance with the present invention;

FIG. 3 is an assembly view of an engaging device of the dejecta collector for pets in accordance with the present invention;

FIG. 4 is a cross-sectional view of a positioning device of the dejecta collector for pets in accordance with the present invention; and

FIG. 5 is a schematic view showing an unfolded loading assembly of the dejecta collector for pets in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

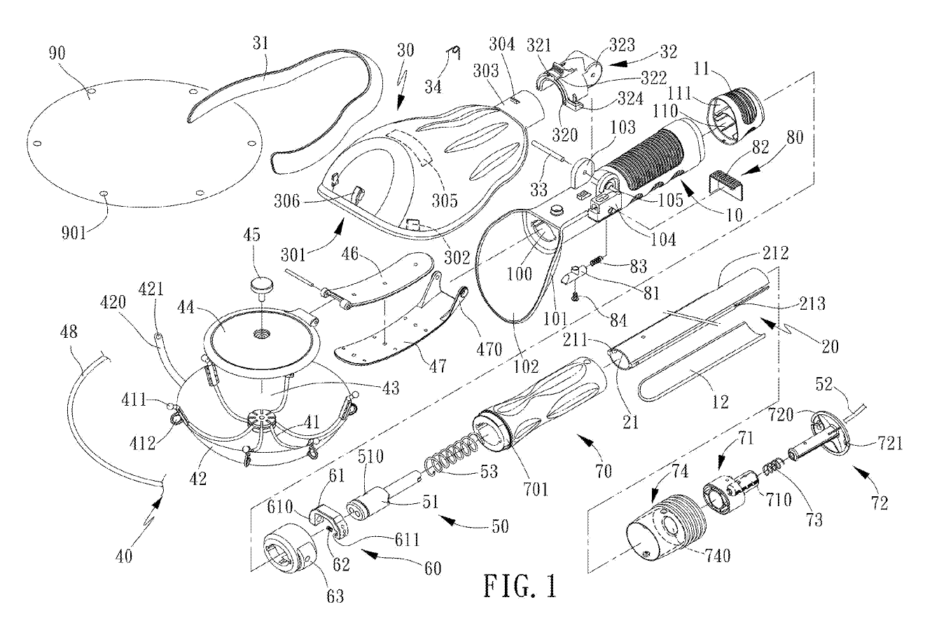

Referring to FIGS. 1-4, a dejecta collector for pets in accordance with the present invention comprises a grip assembly 10, a main body 20, a cover body 30, a loading assembly 40, a pull control device 50, a positioning device 60, a hand-held assembly 70 and an engaging device 80. The engaging device 80 is arranged between the cover body 30 and the grip assembly 10 for mutual engagement to control the cover body 30 to open and close relative to the loading assembly 40. The loading assembly 40 and the grip assembly 10 are respectively stored with a sheet-shaped receiving body 90 capable of forming a bag for receiving and storing the dejecta of the pets.

Referring to FIGS. 1-3, the grip assembly 10 is provided with a through hole 100 which is non-circular in cross section. The cross section of the through hole 100 is in the form of a round hole with an elongated groove at each of two opposite sides thereof. At the distal end of the through hole 100 of the grip assembly 10 is provided a spoon-shaped protecting portion 101 which defines a holding chamber 102 gradually widening outward from the direction of the through hole 100. The grip assembly 10 is provided with a pair of oppositely arranged ear-shaped protruding pivoting portions 103 in the middle thereof for pivotal connection of the cover body 30 by using a pivot pin.

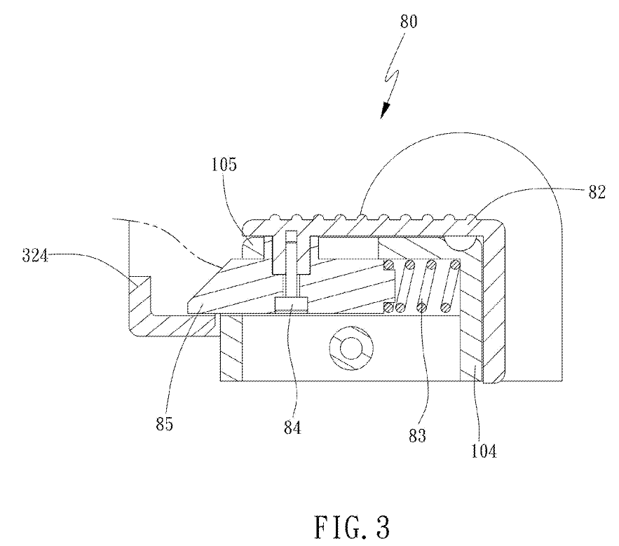

The elastic engaging device 80 is provided at a side of the grip assembly 10 adjacent to an end of the cover body 30. The grip assembly 10 is provided with a combining portion 104 which is opened upwards for engaging with the engaging device 80. As shown in FIG. 3, the engaging device 80 includes an acute engaging body 81 cooperating with a pushing key 82, and a return spring 83 biased between the engaging body 81 and the combining portion 104 for keep pushing the tip end of the engaging boy 81 to extend out of the combining portion 104 in normal condition. The combining portion 104 is provided with an elongated restricting hole 105 for an insertion of a combining bolt 84 which is inserted through the pushing key 82 and the engaging body 81 in such a manner that the pushing key 82 is combined with the engaging body 81 while being limited by the restricting hole 105.

The other end of the grip assembly 10 is an open end sealed with a sealing member 11. The sealing member 11 is a concave structure with an open end and a close end, so that the grip assembly 10, the sealing member 11 and the periphery of the main body 20 can define a space for storing plural folded receiving bodies 90. The sealing member 11 is centrally formed with an inserting hole 110 for mounting the sealing member 11 on the main boy 20. The sealing member 11 is further formed with a containing chamber 111 for cooperating with the opening of the grip assembly 10 to define a containing space for accommodation of the receiving bodies 90 and an arc-shaped digging member 12.

The main body 20 is a hollow round rod provided with a rib at each of two opposite sides thereof. The main body 20 is axially formed with an inner space 21 which is formed with an opening 211 at each of two opposite ends thereof. The grip assembly 10 is mounted on one end of the main body 20. The loading assembly 40 is pivoted to grip assembly 10 and is to be covered and uncovered by the cover body 30 pivoted on the grip assembly 10. The other of the openings 211 of the main body 20 is further engaged with the hand-held assembly 70 which cooperates with the positioning device 60 adjacent to the hand-held assembly 70 to control the pull control device 50 in the main body 20.

The cover body 30 is formed at one end thereof with a receiving portion 301 in the form of a gourd opposite to an end surface of the loading assembly 40. The opening of the receiving portion 301 is provided with plural elastic sheet-shaped embedding portions 302 at the inner periphery thereof for cooperating with the inner surface of the cover boy 30 to clamp a clamping member 31 which is arranged correspondingly to the shape of the opening of the receiving portion 301. The two free ends of the clamping member 31 are engaged between the embedding portion 302 and the inner surface of the cover body 30.

The cover body 30 is formed at the other end thereof with an arc-shaped inserting portion 303. The top of the inserting portion 303 is centrally provided with a protruding engaging portion 304. A cover seat 32 is provided with an arc-shaped inserting groove 320 for insertion of the inserting portion 303 and provided with an elastic fastening portion 321 corresponding to the engaging portion 304. The fastening portion 321 is provided with a slot 322 at each of two opposite sides thereof for offering flexibility to the fastening portion 321. The cover seat 32 is formed with a protruding pivoting portion 323 corresponding to the pivoting portions 103 of the grip assembly 10, so that the cover seat 32 can be pivoted to the grip assembly 10 through a pivot pin 33 around which a torque spring 34 is wound. One end of the torque spring 34 abuts against the cover seat 32, and the other end of the torque spring 34 abuts against the grip assembly 10, so that both cover body 30 and the cover seat 32 have a predetermined opening force. The cover seat 32 is provided with a concave positioning portion 324 aligned with the tip end of the engaging body 81 of the engaging device 80 for facilitation of engaging the engaging body 81 with the cover seat 32, so that the cover seat 32 can be kept in a close state. When the pushing key 82 is pushed back, the engaging body 81 will disengage from the positioning portion 324 while compressing the return spring 83, so as to allow the cover seat 32 to pivot around the pivoting portions 103 of the grip assembly 10 to open the cover body 30. As a result, the loading assembly 40 can be exposed to collect the dejecta of the pets.

The cover body 30 can further be exteriorly provided with a reflective sheet 305 or a light-emitting sheet for facilitating the users to walk with the pets in the dark. In addition, the free end of the cover body 30 is provided with a protruding fastening hook 305 for hooking on the corresponding member of the loading assembly 40, so as to form a secure combination structure.

The loading assembly 40 includes plural rod-shaped supporting members 41 and a sheet-shaped propping member 42. The supporting members 41 are made of an elastic material, and one end of each of the supporting members 41 is inserted into a disc-shaped pivot seat 43 for mutual pivoting connection. The other end of each of the supporting members 41 is free. The respective supporting members 41 are combined to the propping member 42. The supporting members 41 and the propping member 42 can be respectively made of an elastic material or integrally formed of an elastic material.

The propping member 42 is further provided with a soft draught strip 420 on a surface thereof, and the draught strip 420 is provided with a ring-shaped member 421 at the distal end thereof. The ring-shaped member 421 can directly be fastened to the fastening hook 306 after the loading assembly 40 is folded, and the cover body 30 is closed on the loading assembly 40, so as to keep the respective members in a folding state.

The bottom of the loading assembly 40 is centrally provided with an elastic disc-shaped pressing member 44 cooperating with a pressing bolt 45. The pressing bolt 45 is inserted through the pressing member 40 and the pivot seat 43 pivoted to the respective supporting members 41. One end of the pressing member 44 is pivoted to an arc sheet-shaped combining member 46 for making the respective supporting members 41 have normally-open predetermined force. The loading assembly 40 is further provided with an arc sheet-shaped pivoting member 47 at the same position as the combining member 45. The pivoting member 47 is longer than the combining member 45. The combining member 45 cooperates with the pivoting member 47 to clamp the supporting members 41 or the propping member 42. The pivoting member 47 is provided with a pair of oppositely arranged ear-shaped pivoting portions 470 corresponding to the pivoting portions 103 of the main body 20, so that the pivoting portions 470 can be pivoted to pivoting portions 103 of the main body 20 by using a pivot pin, so that the pivoting portions 470 can pivot around the pivoting portions 103 to drive the supporting members 41 to rotate. With the engagement of the pivoting portions 470 with the main body 20, the pivoting member 47 can be kept at a predetermined angle.

The other end of each of the supporting members 41 is provided with an engaging protrusion 411 and a ring 412. The respective engaging protrusions 411 protrude relative to the center of the loading assembly 40, and the respective rings 412 are located outside the whole loading assembly 40 for insertion of an inserting member 48. By releasing and pulling inserting member 48, the propping member 42 can be unfolded or folded with the supporting members 41. The unfolding size of the supporting member 41 is controlled by the propping member 42 for facilitating the collection of the dejecta of the pets. The engaging protrusions 411 of the loading assembly 40 are provided for engagement with a disposable paper receiving body 90.

Both ends of the inserting member 48 are inserted into the inner space 21 through one of the openings 211 of the main body 20. When both ends of the inserting member 48 are subjected to a force, the rings 412 of the loading assembly 40 will be pulled to make the propping member 42 fold with the supporting members 41. When no force is applied to the two ends of the inserting member 48, the rings 412 of the loading assembly 40 will not be pulled, so that the propping member 42 will unfold with the supporting members 41. The cover body 30 can be opened in such a manner that the receiving body 90 can be supported in an open state by the loading assembly 40 for facilitating the collection of dejecta.

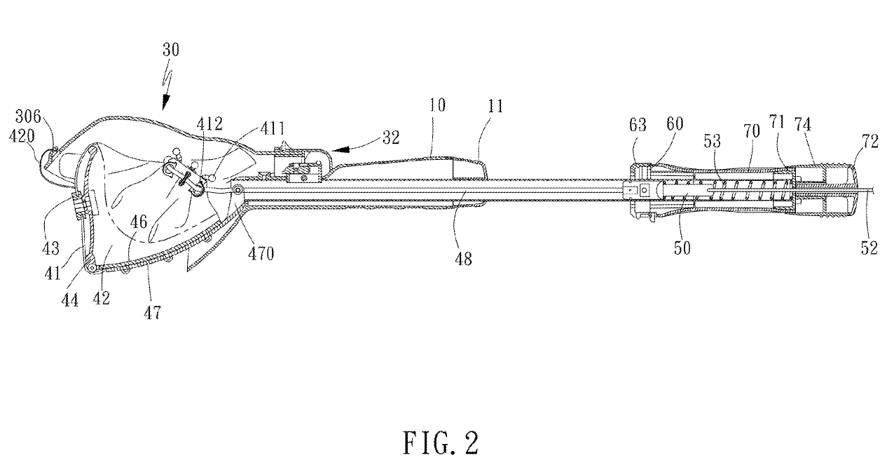

Referring to FIGS. 2-6, the pull control device 50 includes a passive member 51 and an active member 52. A spring-shaped elastic member 53 is mounted on the active member 52 for driving the passive member 51 to move toward the loading assembly 40 automatically. The passive member 51 is inserted into the inner space 21 of the main body 20, and the big-diameter end of the passive member 51 is fixed to both ends of the inserting member 48 and provided with an external concave engaging portion 510. The main body 20 is correspondingly provided at one side thereof with a through inserting portion 212, so that a corresponding component of the positioning device 60 can be inserted through the inserting portion 212 and then engaged with the engaging portion 510 to limit the passive member 51. The main body 20 is further provided at the other side thereof with a concave accommodating portion 213 for the positioning device 60 to cooperate with an elastic structure to realize the positioning function.

The active member 52 can be a pull rope or cable, or a straight rod. In the present embodiment, the active member 52 is a cable, and the cross section of the active member 52 is smaller than that of the main body 20. One end of the active member 52 is inserted into the inner space 21 of the main body 20 and fixed to the other end of the passive member 21 while the other end of the active member 52 is exposed out of the inner space 21 of the main body 20 for the user to apply force on. When the active member 52 is forced to move, the passive member 51 will move the active member 52. The active member 52 can be pulled to drive the passive member 51 to pull and release the inserting member 48 and thus control the folding or unfolding of the supporting members 41 of the loading assembly 40.

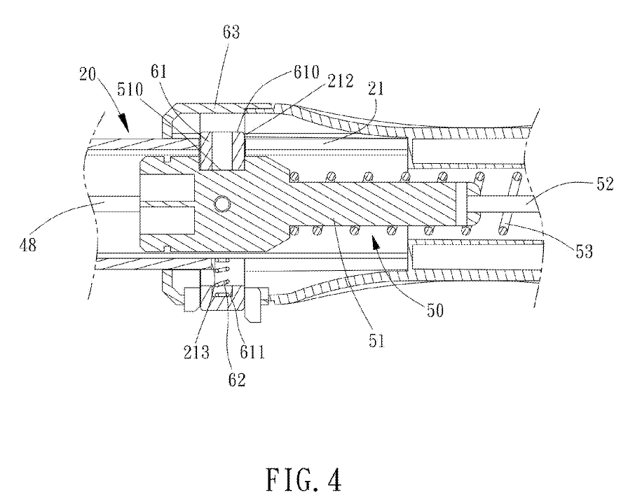

The positioning device 60, as shown in FIG. 4, essentially includes a limiting block 61 and a spring 62. The spring 62 and the limiting block 61 are cooperatingly arranged in the accommodating portion 213 and the inserting portion 212. The spring 62 is biased between the accommodating portion 213 of the main body 20 and the limiting block 61 of the positioning device 60. The limiting block 61 is C-shaped and provided at one end thereof with a stopping portion 610 corresponding to the engaging portion 510. The limiting block 61 is mounted on the main body 20 in such a manner that the stopping portion 610 is engaged in the inserting portion 212 and the engaging portion 510, and the limiting block 61 is provided at the other end thereof with a spring holding portion 611 aligned with the accommodating portion 213. The spring 62 is held in the spring holding portion 611 to push the limiting block 61, so that the stopping portion 610 of the limiting block 61 can be kept engaging in the inserting portion 212 and the engaging portion 510. The spring holding portion 611 is exteriorly provided with a soft pressing block 63, and the periphery of the pressing block 63 is positioned on the hand-held assembly 70 while pressing against the hand-held assembly 70.

The hand-held assembly 70 is provided at one end thereof with a combining portion 701 corresponding to the above pressing block 63 for mutual engagement with the pressing block 701. The other end of the hand-held assembly 70 is extended to one of the openings 211 of the main body 20, in which an end plug 71 is inserted into. The end plug 71 is provided with a hollow combining end 710 exposed out of the opening 211. The exterior of the combining end 710 are respectively engaged with an end stropping member 72 and a return member 73 in the form of a spring. One end of the end stopping member 72, which is rod-shaped, is inserted into the combining end 710, and the other end of the end stopping member 72 is provided with a big-diameter end disc 720. The end disc 720 is provided with a fixing portion 721 in the form of a narrow opening at each of two opposite sides of the circumference thereof in such a manner that the end of the active member 52, which is exposed out of the main body 20, can be wound around therein.

A cylindrical jacket 74 is further provided between the end disc 720 and the hand-held assembly 70. The jacket 74 is radially provided with an inner stopping portion 740 in the middle thereof. Between the stopping portion 740 and the big-diameter end of the end plug 71 is provided the return member 73 in such a manner that an end of the jacket 74 normally abuts against an end of the end disc 720. If the active member 52 is too long, the jacket 74 can be moved axially apart from the end disc 720 to expose the rod-shaped portion of the end stopping member 72, so that the active member 52 can be wound around the rod-shaped portion of the end stopping member 72, and then the jacket 74 will be released, at this moment, the jacket 74 will be pulled by the return member 73 to abut against the end disc 720 again, thus finishing the objective of storing the redundant active member 52.

Additionally, the receiving body 90 is a plastic or paper bag shaped correspondingly to the unfolding loading assembly 40. Because of having flexibility, the receiving body 90 can unfold and fold with the loading assembly 40. The receiving boy 90 is provided with plural inserting holes 901 to be engaged with the engaging protrusions 411 of the loading assembly 40, so that the receiving body 90 can be assuredly engaged with engaging protrusions 411.

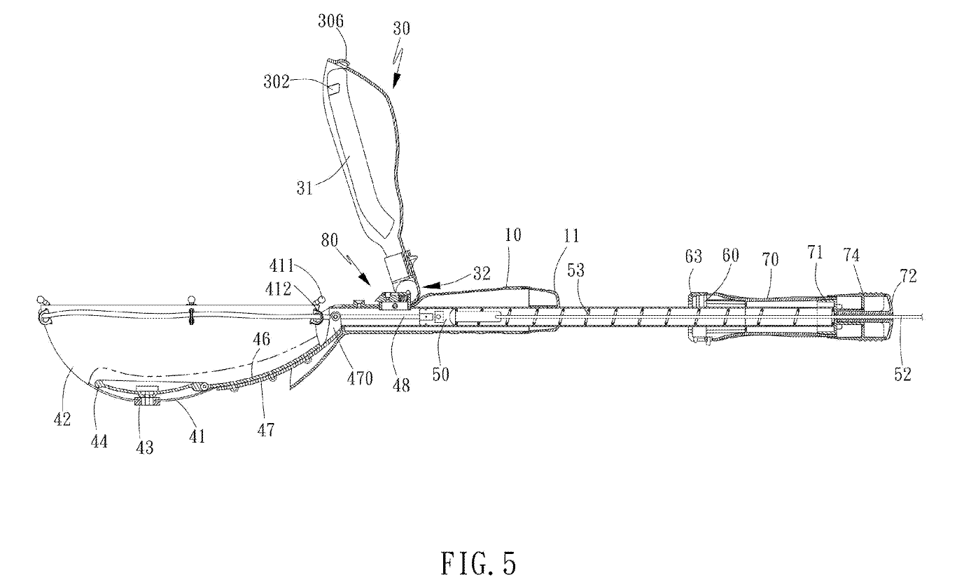

FIGS. 2 and 5 illustrate how the dejecta collector for pets in accordance with the present invention is used. As shown in FIG. 2, when the inserting member 48 is pulled by the pull control device 50 to return to the inner space 21 of the main body 20, the loading assembly 40 will be folded, at this moment, the cover body 30 can fitly cover the loading assembly 40 and engage with the engaging device 80 to be in the close state. When in use, as shown in FIG. 5, the engaging device 80 is released first to open the cover body 30, and then the positioning device 60 will be pressed to disengage the passive member 51 from the limiting block 61, subsequently, the passive member 51 will be subjected to the elastic force of the elastic member 53 to produce a predetermined force of pushing the inserting member out of the inner space 21, after that, the inserting member 48 will unfold the supporting members 41 of the loading assembly 40, and the receiving body 90 is consequentially unfolded by the engaging protrusions 411 of the supporting members 41 to offer the biggest receiving surface for receiving the dejecta of the pets. After the reception, the pull control device 50 and the inserting member 48 will be pulled back until the passive member 51 is engaged with the positioning device 60, and when the dejecta collector for pets can be taken to the rubbish collection point, the loading assembly 40 will be opened to pour out the dejecta of the pets, and further the receiving body 90 can be replaced directly.

As known from further analysis of the above mentioned, the present invention has the following advantages:

1. Convenient and practical: the loading assembly 40 can be unfolded to receive the dejecta of the pets timely and effectively, thus preventing the dejecta from adhering to the body of the pet or polluting other objects or the ground, so that the present invention is very environment-friendly and convenient.

2. Reducing the probability of the occurrence of diseases: after receiving the dejecta of the pets, the receiving body 90 will be stored in the folded loading assembly 40, so that the skin of the pets can breathe freely to avoid the occurrence of the skin diseases, thus saving the money and time on taking the pets to see a doctor.

3. Portable and multiple functions: the main body can be equipped with some components for facilitating the user to carry, and further the main body can assist the disabled in walking, in addition, the cover body 30 is a detachable structure to cooperate with the clamping member 31, so that the user can use the clamping member 31 to pick up the dejecta on the ground and then place the dejecta into the cover body 30, thus offering a function of picking up the dejecta on the ground.

4. The receiving body 90 can be replaced at any moment: the receiving body 90 is a sheet structure capable of forming a bag and engaged with the loading assembly 40, and the receiving body 90 can be folded and stored in the grip assembly 10, so that the receiving body 90 can be disengaged from the loading assembly 40 and replaced at any moment.

While we have shown and described various embodiments in accordance with the present invention, it is clear to those skilled in the art that further embodiments may be made without departing from the scope of the present invention.

What is claimed is:

1. A dejecta collector for pets, comprising:
a main body being a rod;
a loading assembly being connected to an end of the main body; and
a receiving body being sheet-shaped and arranged on a surface of the loading assembly.

2. The dejecta collector for pets as claimed in claim 1, wherein the loading assembly includes plural rod-shaped supporting members and a sheet-shaped propping member, the supporting members are all made of an elastic material, one end of each of the supporting members is pivoted to one another through a pivot seat, the other end of each of the supporting members is free, the propping member is arranged between the supporting members.

3. The dejecta collector for pets as claimed in claim 1, wherein the loading assembly includes plural rod-shaped supporting members and a sheet-shaped propping member, the supporting members and the propping member are integrally formed of an elastic material.

4. A dejecta collector for pets, comprising:
a main body being a rod;
a loading assembly being connected to one end of the main body, the loading assembly including plural elastic rod-shaped supporting members and a sheet-shaped propping member, one end of each of the supporting members being pivoted to one another through a pivot seat, the other end of each of the supporting members being free, the propping member being combined between the supporting members, the free end of each of the supporting members being provided for insertion of an inserting member, both ends of the inserting member being fixed in the main body; and
a receiving body being sheet-shaped and arranged on a surface of the loading assembly.

5. The dejecta collector for pets as claimed in claim 4, wherein a bottom of the loading assembly is centrally provided with an elastic disc-shaped pressing member cooperating with a pressing bolt, the pressing bolt is inserted through the pressing member and the pivot seat, one end of the pressing member is pivoted to an end of a combing member, the loading assembly is further provided with a pivoting member at the same position as the combining member, so as to clamp the supporting members or the propping member, the pivoting member is pivoted to the main body.

6. The dejecta collector for pets as claimed in claim 4, wherein the free end of each of the supporting members is provided with an engaging protrusion and a ring, the respective engaging protrusions protrude relative to a center of the carrying assembly, the ring is arranged outside the whole loading assembly, the inserting member is inserted through the respective rings, the engaging protrusions are provided for engaging with plural inserting holes provided in a disposable receiving body.

7. The dejecta collector for pets as claimed in claim 4 further comprising:
a grip assembly being provided with a through hole;
the main body being a rod, one end of the main body being mounted in the through hole of the grip assembly;
a cover body including a receiving portion and being provided with an inserting portion aligned with an end of the grip assembly;
a cover seat being provided with an inserting groove to be engaged with the inserting portion of the cover body, the cover seat being pivoted to the grip assembly;
the loading assembly being connected to the end of the main body; and
the receiving body being sheet-shaped and arranged on the surface of the loading assembly.

8. The dejecta collector for pets as claimed in claim 7, wherein an opening of the receiving portion of the cover body is provided with plural elastic sheet-shaped embedding portions at an inner periphery thereof, the embedding portions cooperate with an inner surface of the cover body to clamp a clamping member, the clamping member is arranged correspondingly to a shape of the opening of the receiving portion of the cover body, two free ends of the clamping member are engaged between the embedding portions and the inner surface of the cover body, a top of the inserting portion of the cover body is centrally provided with a protruding engaging portion, the cover seat is provided with the inserting groove for insertion of the inserting portion of the cover body and provided with an elastic fastening portion corresponding to the engaging portion of the inserting portion of the cover body, the fastening portion of the cover seat is provided with a slot at each of two opposite sides thereof for offering flexibility to the fastening portion of the cover seat, the cover body is further exteriorly provided with a reflective sheet or a light-emitting sheet, an free end of the cover body is provided with a protruding fastening hook for hooking on a ring-shaped member provided on a distal end of a draught strip on a surface of the propping member of the loading assembly;
the cover seat and the grip assembly are respectively provided with a pivoting portion, so that the cover seat and the grip assembly are pivoted to each other through a pivot pin around which a torque spring is wound, one end of the torque spring abuts against the cover seat, and the other end of the torque spring abuts against the grip assembly, the cover seat is provided with a positioning portion to be engaged with an engaging device, the grip assembly is further provided with a combining portion to be engaged with the engaging device, the combining portion of the grip assembly is provided with a restricting hole, one opening at one end of the grip assembly is provided with a sealing member mounted on the main body, the sealing member defines a containing chamber relative to the grip assembly.

9. The dejecta collector for pets as claimed in claim 8, wherein the engaging device includes an acute engaging body cooperating with a pushing key, and a return spring biased between a tip end of the engaging body and the combining portion of the grip assembly, the pushing key is combined with the engaging body through a combing bolt while being limited by the restricting hole, the tip end of the engaging body is engaged in the positioning portion of the cover seat.

10. The dejecta collector for pets as claimed in claim 7, wherein the grip assembly includes the through hole, at a distal end of the through hole of the grip assembly is provided a spoon-shaped protecting portion which defines a holding chamber gradually widening outward from a direction of the through hole, the other end of the through hole of the grip assembly is provided with the sealing member, the sealing member is provided with an inserting hole aligned with the through hole of the grip assembly, the sealing member is further provided with the containing chamber aligned with the holding chamber.

11. The dejecta collector for pets as claimed in claim 4 further comprising:
the main body being a rod and axially formed with an inner space, the inner space of the main body being formed with an opening at each of two opposite ends thereof;
the loading assembly being connected to the one end of the main body, the loading assembly including plural elastic rod-shaped supporting members and the sheet-shaped propping member, one end of each of the supporting members being pivoted to one another, the other end of each of the supporting members being free, the propping member being combined between the supporting members, the free end of each of the supporting members being provided for insertion of the inserting member, both ends of the inserting member being fixed in the inner space of the main body;
the receiving body being sheet-shaped and arranged on the surface of the loading assembly;
a pull-control device including an active member and a passive member, the passive member being arranged in the inner space of the main body and connected with both ends of the inserting member being inserted into the inner space of the main body, the passive member being connected to one end of the active member, and the other end of the active member being exposed out of one end of the main body;
a hand-held assembly, one end of the hand-held assembly being mounted on the main body, and the active member being exposed out of the other end of the hand-held assembly; and
a positioning device being arranged adjacent to the other end of the hand-held assembly to control the passive member of the pull control device in the main body.

12. The dejecta collector for pets as claimed in claim 11, wherein the pull control device includes the passive member and the active member, a spring-shaped elastic member is mounted on the active member for driving the passive member to move toward the loading assembly, the passive member is inserted into the inner space of the main body, a big-diameter end of the passive member is fixed to both ends of the inserting member and provided with an external concave engaging portion, the main body is correspondingly provided in one side thereof with an inserting portion in a surface thereof, so that a corresponding component of the positioning device is inserted through the inserting portion of the main body and then engaged with the engaging portion of the pull control device to limit the passive member of the control device, the main body is further provided in the other side thereof with a concave accommodating portion;
the active member is a pull rope, a cable, or a straight rod, a cross section of the active member is smaller than that of the main body, one end of the active member is inserted into the inner space of the main body and fixed to the other end of the passive member while the other end of the active member is exposed out of the inner space of the main body for the user to apply force on.

13. The dejecta collector for pets as claimed in claim 11, wherein the positioning device includes a limiting block and a spring, the spring and the limiting block are cooperatingly arranged in the accommodating portion and the inserting portion of the main body, the spring is biased between the accommodating portion of the main body and the limiting block, the limiting block is C-shaped and provided at one end thereof with a stopping portion corresponding to the engaging portion of the pull control device, the limiting block is mounted on the main body in such a manner that the stopping portion of the limiting block is engaged in the inserting portion of the main body and the engaging portion of the pull control device, and the limiting block is provided at the other end thereof with a spring holding portion aligned with the accommodating portion, the spring of the positioning device is held in the spring holding portion of the limiting block to push the limiting block, so that the stopping portion of the limiting block is kept engaging in the inserting portion of the main body and the engaging portion of the passive member of the pull control device, the spring holding portion of the limiting block is exteriorly provided with a soft pressing block, and a periphery of the pressing block is positioned on the hand-held assembly while pressing against the hand-held assembly, the hand-held assembly is provided at one end thereof with a combining portion corresponding to the pressing block of the limiting block for mutual engagement.

14. The dejecta collector for pets as claimed in claim 11, wherein the other end of the hand-held assembly is extended to the opening at a distal end of the main body, into which an end plug is inserted, the end plug is provided with a hollow combining end exposed out of the opening at the distal end of the main body, an exterior of the combining end of the end plug are respectively engaged with an end stropping member and a return member in the form of a spring, one end of the end stopping member, which is rod-shaped, is inserted into the combining end, and the other end of the stopping member is provided with a big-diameter end disc, the end disc of the end stopping member is provided with a fixing portion in the form of a narrow opening at each of two opposite sides of a circumference thereof in such a manner that an end of the active member, which is exposed out of the main body, is wound around therein; and
a cylindrical jacket is further provided between the end disc and the hand-held assembly, the jacket is radially provided with an inner stopping portion in the middle thereof, between the stopping portion of the jacket and the big-diameter end of the end plug is provided the return member of the hand-held assembly in such a manner that an end of the jacket normally abuts against an end of the end disc.

15. The dejecta collector for pets as claimed in claim 11, wherein the receiving body is a sheet structure shaped correspondingly to an unfolding loading assembly, because of having flexibility, the receiving body unfolds and folds with the loading assembly, the receiving body is provided with plural inserting holes to be engaged with the engaging protrusions of the loading assembly.

16. The dejecta collector for pets, comprising:
a cover body including a receiving portion, the receiving portion is provided with an elastic sheet-shaped embedding portion at an inner periphery of an opening thereof, the embedding portion and an inner surface of the cover boy clamp a clamping member which is shaped correspondingly to a shape of the opening of the receiving portion, two free ends of the clamping member are detachably engaged between the embedding portion and the inner surface of the cover body.
